(19) United States
(12) Patent Application Publication
(10) Pub. No.: US 2022/0180119 A1
(43) Pub. Date: Jun. 9, 2022

(54) CHART MICRO-CLUSTER DETECTION

(71) Applicant: International Business Machines Corporation, Armonk, NY (US)

(72) Inventors: Eugene Irving Kelton, Wake Forest, NC (US); Willie Robert Patten, JR., Hurdle Mills, NC (US); Brandon Harris, Union City, NJ (US); Yi-Hui Ma, Mechanicsburg, PA (US)

(21) Appl. No.: 17/116,248

(22) Filed: Dec. 9, 2020

(51) Int. Cl. G06K 9/62; G06N 3/04

(52) U.S. Cl. CPC G06K 9/6223; G06N 3/0454; G06K 9/6215; G06K 9/623

(57) ABSTRACT

One or more computer processors select a plurality of key-events contained in a dataset. The one or more computer processors determine a plurality of chart parameters based on the dataset. The one or more computer processors generate a plurality of charts utilizing the determined plurality of chart parameters, selected key-events, associated data, and a timeline generator. The one or more computer processors cluster the generated plurality of charts into a one or more chart macro-clusters. The one or more computer processors decompose the one or more chart macro-clusters into one or more chart micro-clusters.

### BACKGROUND

The present invention relates generally to the field of machine learning, and more particularly to clustering continuous data through generated charts.

Computer vision is an interdisciplinary scientific field that deals with how computers can gain high-level understanding from digital images or videos. Computer vision tasks include methods for acquiring, processing, analyzing, and understanding digital images, and extraction of high-dimensional data from the real world in order to produce numerical or symbolic information.

Convolutional neural networks (CNN) are a class of neural networks, most commonly applied to analyzing visual imagery. CNNs are regularized versions of multilayer perceptrons (e.g., fully connected networks), where each neuron in one layer is connected to all neurons in the next layer. CNNs take advantage of the hierarchical pattern in data and assemble more complex patterns using smaller and simpler patterns. CNNs break down images into small patches (e.g., 5×5 pixel patch), then moves across the image by a designated stride length. Therefore, on the scale of connectedness and complexity, CNNs are on the lower extreme. CNNs use relatively little pre-processing compared to other image classification algorithms, allowing the network to learn the filters that in traditional algorithms were hand-engineered.

### SUMMARY

Embodiments of the present invention disclose a computer-implemented method, a computer program product, and a system. The computer-implemented method includes one or more computer processers selecting a plurality of key-events contained in a dataset. The one or more computer processors determine a plurality of chart parameters based on the dataset. The one or more computer processors generate a plurality of charts utilizing the determined plurality of chart parameters, selected key-events, associated data, and a timeline generator. The one or more computer processors cluster the generated plurality of charts into a one or more chart macro-clusters. The one or more computer processors decompose the one or more chart macro-clusters into one or more chart micro-clusters.

### BRIEF DESCRIPTION OF THE DRAWINGS

FIG. 1 is a functional block diagram illustrating a computational environment, in accordance with an embodiment of the present invention;

FIG. 2 is a flowchart depicting operational steps of a program, on a server computer within the computational environment of FIG. 1, for identifying and decomposing micro-clusters in continuous data through generated charts, in accordance with an embodiment of the present invention;

FIG. 3 is an example illustration of a plurality of micro-clustered charts depicting operational steps of a program within the computational environment of FIG. 1, in accordance with an embodiment of the present invention; and

FIG. 4 is a block diagram of components of the server computer, in accordance with an embodiment of the present invention.

### DETAILED DESCRIPTION

Identifying patterns and appropriate clusters for continuous data, specifically timeseries data, can be difficult and computationally expensive due to an exponential number of associated features. Traditional clustering methods suffer greatly in efficiency and accuracy when confronted with vast quantities of historical continuous data, such as transactional history for a retail store. Often traditional systems struggle when clustering multiple continuous datasets that vary substantially in data type, structure, and size.

Embodiments of the present invention improve continuous data clustering through the utilization of computer vision and deep learning on generated historical chart images. Embodiments of the present invention recognize that clustering is improved when generating charts utilizing divergent data, where the generated charts standardize said divergent data. Embodiments of the present invention recognize that image clustering after a preliminary chart labeling process allows for further cluster decompositions into micro-clusters. Embodiments of the present invention target focal objects (e.g., customers, accounts) and key-events (e.g., outliers, etc.) presented in continuous data. Embodiments of the present invention further improve micro-clustering by identifying and standardizing focal objects with highly variable number of historical continuous data (i.e., transactions) to predict subsequent actions. Embodiments of the present invention improve continuous data clustering by identifying similarities between generated charts in multiple macro-clusters. Embodiments of the present invention allow for greater texture and applicability to modeling results with a reduction of noise introduced by dissimilar clusters. Implementation of embodiments of the invention may take a variety of forms, and exemplary implementation details are discussed subsequently with reference to the Figures.

The present invention will now be described in detail with reference to the Figures.

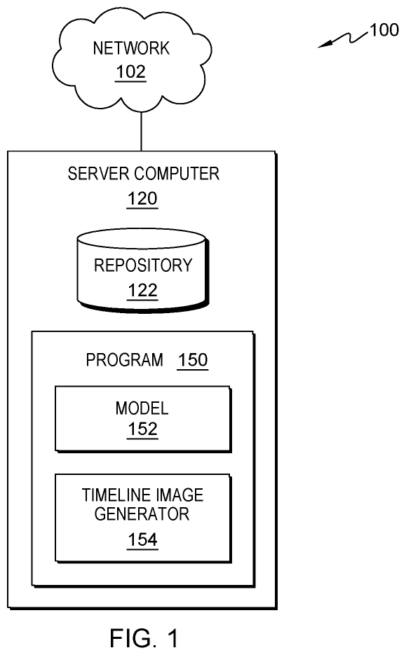

FIG. 1 is a functional block diagram illustrating a computational environment, generally designated 100, in accordance with one embodiment of the present invention. The term “computational” as used in this specification describes a computer system that includes multiple, physically, distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Computational environment 100 includes server computer 120 connected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks that are capable of receiving and transmitting data, voice, and/or video signals, including multimedia signals that include voice, data, and video information. In general, network 102 can be any combination of connections and protocols that will support communications between server computer 120, and other computing devices (not shown) within computational environment 100. In various embodiments, network 102 operates locally via wired, wireless, or optical connections and can be any combination of connections and protocols (e.g., personal area network (PAN), near field communication (NFC), laser, infrared, ultrasonic, etc.).

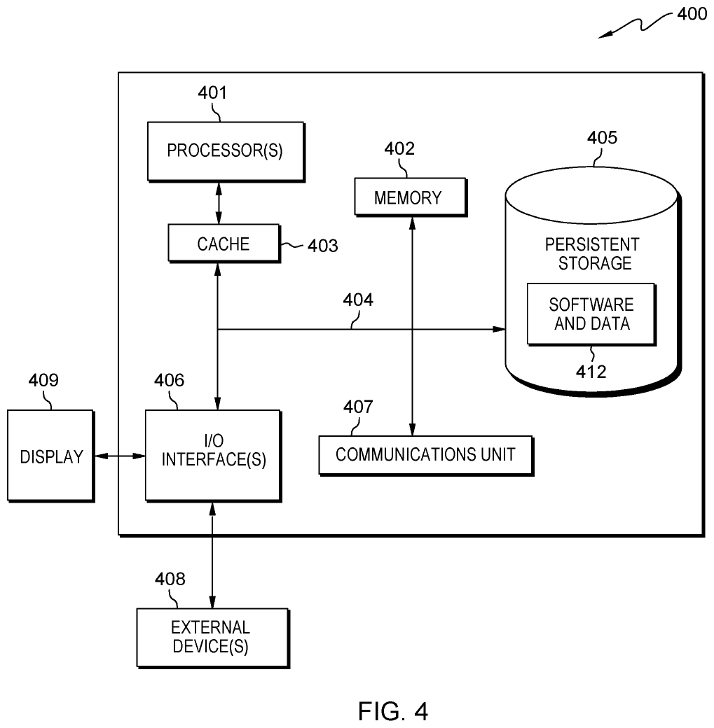

Server computer 120 can be a standalone computing device, a management server, a web server, a mobile computing device, or any other electronic device or computing system capable of receiving, sending, and processing data. In other embodiments, server computer 120 can represent a server computing system utilizing multiple computers as a server system, such as in a cloud computing environment. In another embodiment, server computer 120 can be a laptop computer, a tablet computer, a netbook computer, a personal computer (PC), a desktop computer, a personal digital assistant (PDA), a smart phone, or any programmable electronic device capable of communicating with other computing devices (not shown) within computational environment 100 via network 102. In another embodiment, server computer 120 represents a computing system utilizing clustered computers and components (e.g., database server computers, application server computers, etc.) that act as a single pool of seamless resources when accessed within computational environment 100. In the depicted embodiment, server computer 120 includes repository 122 and program 150. In other embodiments, server computer 120 may contain other applications, databases, programs, etc. which have not been depicted in computational environment 100. Server computer 120 may include internal and external hardware components, as depicted and described in further detail with respect to FIG. 4.

Repository 122 is a repository for data used by program 150. In the depicted embodiment, repository 122 resides on server computer 120. In another embodiment, repository 122 may reside elsewhere within computational environment 100 provided program 150 has access to repository 122. A database is an organized collection of data. Repository 122 can be implemented with any type of storage device capable of storing data and configuration files that can be accessed and utilized by program 150, such as a database server, a hard disk drive, or a flash memory. In an embodiment, repository 122 stores continuous data used by program 150, such as historically generated charts (e.g., graphs, bar charts, line charts, timelines, stacked bar, pie, area, etc.) and historical continuous datasets (e.g., financial data, transactional data, any data with a timeseries, etc.). In a further embodiment, repository 122 comprises transactional data describing purchases, returns, invoices, payments, credits, debits, trades, sales, and/or payroll associated with an entity (e.g., individual, organization, company, etc.).

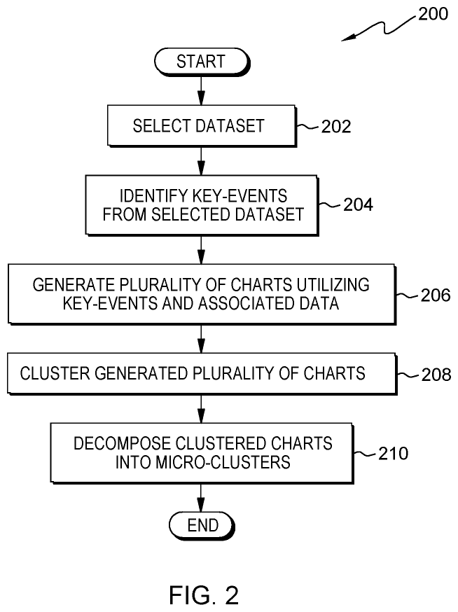

Program 150 is a program for identifying micro-clusters in continuous data through generated charts. In various embodiments, program 150 may implement the following steps: select a plurality of key-events contained in a dataset; determine a plurality of chart parameters based on the dataset; generate a plurality of charts utilizing the determined plurality of chart parameters, selected key-events, associated data, and a timeline generator; cluster the generated plurality of charts into a one or more chart macro-clusters; and decompose the one or more chart macro-clusters into one or more chart micro-clusters. In the depicted embodiment, program 150 is a standalone software program. In another embodiment, the functionality of program 150, or any combination programs thereof, may be integrated into a single software program. In some embodiments, program 150 may be located on separate computing devices (not depicted) but can still communicate over network 102. In various embodiments, client versions of program 150 resides on any other computing device (not depicted) within computational environment 100. In the depicted embodiment, program 150 includes model 152 and timeline generator 154. Program 150 is depicted and described in further detail with respect to FIG. 2.

Model 152 utilizes deep learning techniques to identify similar charts or chart subregions based on a plurality of features contained in a continuous or timeseries dataset. In an embodiment, model 152 calculates a relative micro-profiling score for a cluster, where model 152 utilizes an out-of-bag technique. In this embodiment, model 152 generates a respective cluster relationship strength score for each chart in a cluster, where each chart is compared (generated cluster relationship strength score) to each remaining chart in said cluster. Model 152 aggregates said generated inter-cluster similarity scores forming the relative micro-profiling score for the associated cluster. In a further embodiment, program 150 decomposes cluster with a high relative micro-profiling score into subsequent micro-clusters. Specifically, model 152 utilizes transferrable neural networks algorithms and models (e.g., long short-term memory (LSTM), deep stacking network (DSN), deep belief network (DBN), convolutional neural networks (CNN), compound hierarchical deep models, etc.) that can be trained with supervised and/or unsupervised methods. In the depicted embodiment, model 152 utilizes a CNN trained utilizing historical continuous data, such as historical transactional datasets. Model 152 assesses a plurality of charts by considering different key attributes (e.g., significant features) and associated key-events (e.g., transactions associated with one or more significant features), available as structured data, and applying relative numerical weights. In various embodiments, the charts are labeled with an associated classification enabling model 152 to learn what features are correlated to a specific classification, prior to use. Program 150 is depicted and described in further detail with respect to FIG. 2.

Timeline generator 154 is a generative adversarial network (GAN) comprising two adversarial neural networks (i.e., generator and discriminator) trained utilizing unsupervised and supervised methods with historical charts corresponding to a plurality of chart parameters including, but not limited to, chart type (e.g., graph, line chart, etc.), normalized time scales, data color coding, text labeling, and associated annotations. In an embodiment, program 150 trains a discriminator utilizing known data as described in repository 122. In another embodiment, program 150 initializes a generator utilizing randomized input data sampled from a predefined latent space (e.g. a multivariate normal distribution), thereafter, candidates synthesized by the generator are evaluated by the discriminator. In this embodiment, program 150 applies backpropagation to both networks so that the generator produces better charts, while the discriminator becomes more skilled at flagging synthetic and/or illogical charts. In the depicted embodiment, the generator is a deconvolutional neural network and the discriminator is a convolutional neural network.

The present invention may contain various accessible data sources, such as repository 122, that may include personal storage devices, data, content, or information the user wishes not to be processed. Processing refers to any, automated or unautomated, operation or set of operations such as collection, recording, organization, structuring, storage, adaptation, alteration, retrieval, consultation, use, disclosure by transmission, dissemination, or otherwise making available, combination, restriction, erasure, or destruction performed on personal data. Program 150 provides informed consent, with notice of the collection of personal data, allowing the user to opt in or opt out of processing personal data. Consent can take several forms. Opt-in consent can impose on the user to take an affirmative action before the personal data is processed. Alternatively, opt-out consent can impose on the user to take an affirmative action to prevent the processing of personal data before the data is processed. Program 150 enables the authorized and secure processing of user information, such as tracking information, as well as personal data, such as personally identifying information or sensitive personal information. Program 150 provides information regarding the personal data and the nature (e.g., type, scope, purpose, duration, etc.) of the processing. Program 150 provides the user with copies of stored personal data. Program 150 allows the correction or completion of incorrect or incomplete personal data. Program 150 allows the immediate deletion of personal data.

FIG. 2 depicts flowchart 200 illustrating operational steps of program 150 for identifying micro-clusters in continuous data through generated charts, in accordance with an embodiment of the present invention.

Program 150 selects a dataset (step 202). In an embodiment, program 150 initiates responsive to a received dataset containing continuous data. In a continuing example, program 150 receives a dataset containing a timeseries of purchasing transactional data for a plurality of companies. In this example, the transactional data (i.e., continuous data) has been collected over a period of time (e.g., months, years, etc.).

Program 150 selects key-events from the selected dataset (step 204). In an embodiment, program 150 identifies categorical variables (e.g., variables that can take on one of a limited number of possible values, assigning each data point to a particular group or nominal category on the basis of a qualitative property) in the received dataset through a feature identification process, such as any statistical-based feature selection method that evaluates the relationship between each input variable and the target variable. For example, program 150 identifies region, product, sales, country, and city as categorical (e.g., classifications, labels, etc.). Here, program 150 selects categorical variables that have the strongest relationship (e.g., largest impact) with the target variable. In a further embodiment, program 150 utilizes expert review of the identified categorical variables to further reduce the feature set into key attributes (e.g., features with relatively high impact on an output). Based on the selected key attributes, program 150 determines a global relevant timespan in the data and partitions the transactional data based temporal period (e.g., season, month, year, etc.). For example, program 150 selects a time period large enough to encompass all datapoints containing the selected key attribute.

In some embodiments, program 150 identifies key-events in the selected dataset utilizing the selected key attributes, wherein key-events represent potential outliers or an event of relative importance. In an embodiment, key-events, as used herein, a key event, indicates an abnormality (e.g., statistically significant) or deviation in activity, where the activity can include financial transactions such as deposits, withdrawals, investments. In another embodiment, the activity can be unique to a focal object. For example, where the activity is specified as consumption of goods (e.g., energy), an abnormality in activity could be a change in consumption of energy that is one standard deviation above or below the mean consumption levels for the focal object. In the continuing example, program 150 identifies major purchasing deviations (i.e., key-events) and associated key attributes, variables, or values for the plurality of companies. In another example, the selected dataset contains timeseries of energy consumption in commercial or residential buildings. In this example, program 150 identifies abnormal consumption (i.e., key-events) where energy consumption varies from normal as determined using standard scores for associated key attributes. In an embodiment, program 150 utilizes the identified categorical variables as macro-cluster labels. In these embodiments, program 150 targets focal objects (e.g., individuals, accounts, companies, organizations, etc.) and key-events (e.g., outliers, etc.) presented in continuous data.

Program 150 generates a plurality of charts utilizing the selected key-events and associated data (step 206). In an embodiment, program 150 determines a plurality of chart parameters that control the generation of one or more charts based on respective data. In this embodiment, chart parameters include, but are not limited to, chart type (e.g., graph, line chart, etc.), normalized time scales, data color coding, text labeling, and associated annotations (e.g., transaction metadata). In an embodiment, program 150 determines a time scale based on the identified global relevant timespan, as described in step 204. For example, program 150 determines a timescale of months for an identified global relevant timespan measured in years. In a further embodiment, program 150 normalizes the timeseries data associated with the identified global relevant timespan. Here, normalizing adjusts (e.g., extend or reduce) a generated chart to a timescale that does not disproportionately present a time period more than any other time period. In an embodiment, program 150 determines a data color coding for key attributes. In this embodiment, the data color coding is determined utilizing a color scale or color palette to link similar key-events in a chart or group of charts. For example, similar transactions or transaction types are coded with a similar color palette. In a further embodiment, program 150 determines data text labeling utilizing the identified categorical variables in step 204. In another embodiment, program 150 determines a chart type to generate that best presents the continuous data. In this embodiment, program 150 receives user input regarding a chart preference. In another embodiment, program 150 determines a chart type by utilizing historical charts to identify an appropriate chart. In various embodiment, program 150 determines a plurality of chart types. For example, program 150 generates a bar chart for a timeseries containing profit/loss data.

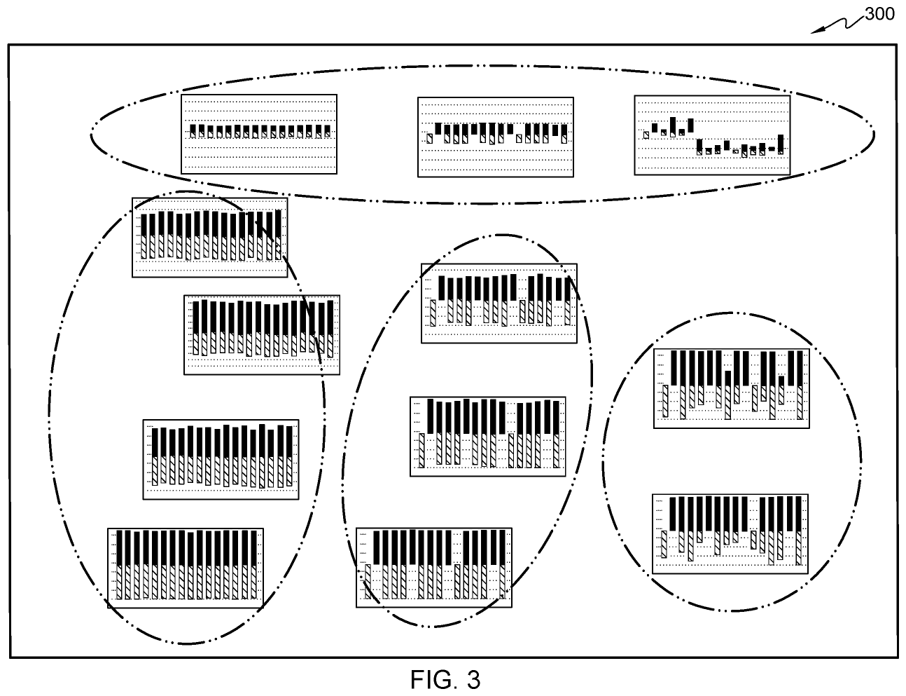

Responsive to the determined chart parameters, program 150 utilizes timeline generator 154 to generate a plurality of charts utilizing the determined chart parameters, selected key-events, and associated data. In the continuing example, program 150 generates a bar chart detailing profit/loss in a five-year timespan for each company in the plurality of companies. In this example, program m150 generates the bar char to include key-events for each company specific to one or more key attributes (e.g., key features associated with the chart). In an embodiment, timeline generator 154 is a GAN trained with historical charts to generate charts based on input continuous data, key-events, and chart parameters. FIG. 3 further depicts a plurality of generated charts.

Program 150 clusters the generated plurality of charts (step 208). Program 150 initially clusters the generated charts utilizing associated macro-cluster labels as identified in step 204. In an embodiment, program 150 utilizes one or more clustering models and/or algorithms (e.g., binary classifiers, multi-class classifiers, multi-label classifiers, Naïve Bayes, k-nearest neighbors, random forest, etc.) to create a plurality of chart macro-clusters representing a high level view of the charts and contained data. In the continuing example, program 150 clusters the generated bar charts based on identified key attributes. In an embodiment, program 150 utilizes a classification model to identify and assign a label to created chart macro-clusters.

Program 150 decomposes the clustered charts into micro-clusters (step 210). Responsive to generated chart macro-clusters, program 150 decomposes each macro-cluster into one or more micro-clusters. In an embodiment, program 150 rates and orders each macro-cluster by a relative micro-profiling impact score. In this embodiment, program 150 calculates the relative micro-profiling score utilizing model 152. In the depicted embodiment, model 152 is a trained CNN. In an embodiment, program 150 utilizes model 152 to generate an relative micro-profiling impact score for each macro-cluster by generating a cluster relationship strength score for each contained chart, where higher cluster relationship strength scores represent higher similarity between the charts in the macro-cluster. In an embodiment, model 152 calculates a relative micro-profiling score for a cluster, where model 152 utilizes an out-of-bag technique. In this embodiment, model 152 generates a respective cluster relationship strength score for each chart in a cluster, where each chart is compared (generated cluster relationship strength score) to each remaining chart in said cluster. Model 152 aggregates said generated inter-cluster similarity scores forming the relative micro-profiling score for the associated macro-cluster. In a further embodiment, program 150 decomposes macro-cluster with a high relative micro-profiling score into subsequent micro-clusters. In a further embodiment, program 150 lists and orders (i.e., ranks) each macro-cluster based respective relative micro-profiling score, wherein higher relative micro-profiling scores represents a higher rank on the list.

Responsively, program 150 performs unsupervised clustering on the highest order macro-cluster to decompose the macro-cluster into micro-clusters. In an embodiment, program 150 continues to perform unsupervised chart clustering (e.g., K-Means) on each macro-cluster with a relative micro-profiling score exceeding a micro-profiling threshold. Embodiments of the present invention recognize that image clustering after a preliminary chart labeling process allows for further cluster decompositions into micro-labeled clusters. In an embodiment, program 150 labels an emerging micro-cluster with an identified key attribute present in the micro-cluster. In another embodiment, program 150 removes charts determined to be outside of a general transactional pattern due to low cluster relationship strength (e.g., failing to reach a threshold) allowing for greater texture and applicability to modeling results with a reduction of noise introduced by dissimilar clusters. In another embodiment, program 150 allows the expert review of micro-clusters, further finetuning the method and clusters. In a further embodiment, program 150 retains model 152 and timeline generator 154 based on the decomposed micro-clusters and subsequent expert review. In another embodiment, program 150 utilizes the micro-clusters to identify subsequent actions. In the continuing example, program 150 utilizes the micro-clusters of transactions to identify potential cost-saving opportunities or identify potential corporate waste or inefficiencies. In another example, program 150 utilizes the micro-clusters to develop fault detection and a diagnostic model for building energy consumption.

FIG. 3 depicts example 300, in accordance with an illustrative embodiment of the present invention. Example 300 depicts a plurality of clustered generated charts, where each chart is a bar chart comprising a plurality of transactions represented as a plurality of bars having a height proportional to a transaction amount, the bar being located along a time axis of the bar chart according to a determined global timespan. The charts depicted in example 300 are clustered into macro-clusters and further decomposed micro-clusters.

FIG. 4 depicts block diagram 400 illustrating components of server computer 120 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Server computer 120 each include communications fabric 404, which provides communications between cache 403, memory 402, persistent storage 405, communications unit 407, and input/output (I/O) interface(s) 406. Communications fabric 404 can be implemented with any architecture designed for passing data and/or control information between processors (such as microprocessors, communications, and network processors, etc.), system memory, peripheral devices, and any other hardware components within a system. For example, communications fabric 404 can be implemented with one or more buses or a crossbar switch.

Memory 402 and persistent storage 405 are computer readable storage media. In this embodiment, memory 402 includes random access memory (RAM). In general, memory 402 can include any suitable volatile or non-volatile computer readable storage media. Cache 403 is a fast memory that enhances the performance of computer processor(s) 401 by holding recently accessed data, and data near accessed data, from memory 402.

Program 150 may be stored in persistent storage 405 and in memory 402 for execution by one or more of the respective computer processor(s) 401 via cache 403. In an embodiment, persistent storage 405 includes a magnetic hard disk drive. Alternatively, or in addition to a magnetic hard disk drive, persistent storage 405 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 405 may also be removable. For example, a removable hard drive may be used for persistent storage 405. Other examples include optical and magnetic disks, thumb drives, and smart cards that are inserted into a drive for transfer onto another computer readable storage medium that is also part of persistent storage 405. Software and data 412 can be stored in persistent storage 405 for access and/or execution by one or more of the respective processors 401 via cache 403.

Communications unit 407, in these examples, provides for communications with other data processing systems or devices. In these examples, communications unit 407 includes one or more network interface cards. Communications unit 407 may provide communications through the use of either or both physical and wireless communications links. Program 150 may be downloaded to persistent storage 405 through communications unit 407.

I/O interface(s) 406 allows for input and output of data with other devices that may be connected to server computer 120. For example, I/O interface(s) 406 may provide a connection to external device(s) 408, such as a keyboard, a keypad, a touch screen, and/or some other suitable input device. External devices 408 can also include portable computer readable storage media such as, for example, thumb drives, portable optical or magnetic disks, and memory cards. Software and data used to practice embodiments of the present invention, e.g., program 150, can be stored on such portable computer readable storage media and can be loaded onto persistent storage 405 via I/O interface(s) 406. I/O interface(s) 406 also connect to a display 409.

Display 409 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, conventional procedural programming languages, such as the “C” programming language or similar programming languages, and quantum programming languages such as the “Q” programming language, Q#, quantum computation language (QCL) or similar programming languages, low-level programming languages, such as the assembly language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
selecting, by one or more computer processors, a plurality of key-events contained in a dataset;
determining, by one or more computer processors, a plurality of chart parameters based on the dataset;
generating, by one or more computer processors, a plurality of charts utilizing the determined plurality of chart parameters, selected key-events, associated data, and a timeline generator;
clustering, by one or more computer processors, the generated plurality of charts into a one or more chart macro-clusters; and
decomposing, by one or more computer processors, the one or more chart macro-clusters into one or more chart micro-clusters.

2. The computer-implemented method of claim 1, wherein decomposing the one or more chart macro-clusters into one or more chart micro-clusters, comprises:
calculating, by one or more computer processors, a relative micro-profiling impact score for each chart macro-cluster in the one or more chart macro-clusters; and
responsive to reaching a micro-profiling threshold, decomposing, by one or more computer processors, one or more chart macro-clusters into one or more respective chart micro-clusters.

3. The computer-implemented method of claim 2, wherein calculating the relative micro-profiling impact score for each chart macro-cluster in the one or more chart macro-clusters, comprises:
generating, by one or more computer processors, a cluster relationship strength score for each chart contained in a respective chart macro-cluster utilizing a trained convolutional neural network, wherein a higher cluster relationship strength scores represents higher similarity between a chart and remaining charts the respective chart macro-cluster; and
aggregating, by one or more computer processors, each calculated cluster relationship strength score into the relative micro-profiling impact score for the associated cluster.

4. The computer-implemented method of claim 1, wherein the chart parameters include normalized time scales, data color coding, text labeling, and associated annotations.

5. The computer-implemented method of claim 1, wherein the timeline generator is a generative adversarial network.

6. The computer-implemented method of claim 1, wherein the dataset is a timeseries dataset.

7. The computer-implemented method of claim 6, wherein the timeseries dataset contains transactional data associated with a plurality of focal objects.

8. A computer program product comprising:
one or more computer readable storage media and program instructions stored on the one or more computer readable storage media, the stored program instructions comprising:
program instructions to select a plurality of key-events contained in a dataset;
program instructions to determine a plurality of chart parameters based on the dataset;
program instructions to generate a plurality of charts utilizing the determined plurality of chart parameters, selected key-events, associated data, and a timeline generator;
program instructions to cluster the generated plurality of charts into a one or more chart macro-clusters; and
program instructions to decompose the one or more chart macro-clusters into one or more chart micro-clusters.

9. The computer program product of claim 8, wherein the program instructions to decompose the one or more chart macro-clusters into one or more chart micro-clusters, comprise:
program instructions to calculate a relative micro-profiling impact score for each chart macro-cluster in the one or more chart macro-clusters; and
program instructions to responsive to reaching a micro-profiling threshold, decompose one or more chart macro-clusters into one or more respective chart micro-clusters.

10. The computer program product of claim 9, wherein the program instructions to calculate the relative micro-profiling impact score for each chart macro-cluster in the one or more chart macro-clusters, comprise:
program instructions to generate a cluster relationship strength score for each chart contained in a respective chart macro-cluster utilizing a trained convolutional neural network, wherein a higher cluster relationship strength scores represents higher similarity between a chart and remaining charts the respective chart macro-cluster; and
program instructions to aggregate each calculated cluster relationship strength score into the relative micro-profiling impact score for the associated cluster.

11. The computer program product of claim 8, wherein the chart parameters include normalized time scales, data color coding, text labeling, and associated annotations.

12. The computer program product of claim 8, wherein the timeline generator is a generative adversarial network.

13. The computer program product of claim 8, wherein the dataset is a timeseries dataset.

14. The computer program product of claim 13, wherein the timeseries dataset contains transactional data associated with a plurality of focal objects.

15. A computer system comprising:
one or more computer processors;
one or more computer readable storage media; and
program instructions stored on the computer readable storage media for execution by at least one of the one or more processors, the stored program instructions comprising:
program instructions to select a plurality of key-events contained in a dataset;
program instructions to determine a plurality of chart parameters based on the dataset;
program instructions to generate a plurality of charts utilizing the determined plurality of chart parameters, selected key-events, associated data, and a timeline generator;
program instructions to cluster the generated plurality of charts into a one or more chart macro-clusters; and
program instructions to decompose the one or more chart macro-clusters into one or more chart micro-clusters.

16. The computer system of claim 15, wherein the program instructions to decompose the one or more chart macro-clusters into one or more chart micro-clusters, comprise:
program instructions to calculate a relative micro-profiling impact score for each chart macro-cluster in the one or more chart macro-clusters; and
program instructions to responsive to reaching a micro-profiling threshold, decompose one or more chart macro-clusters into one or more respective chart micro-clusters.

17. The computer system of claim 16, wherein the program instructions to calculate the relative micro-profiling impact score for each chart macro-cluster in the one or more chart macro-clusters, comprise:
program instructions to generate a cluster relationship strength score for each chart contained in a respective chart macro-cluster utilizing a trained convolutional neural network, wherein a higher cluster relationship strength scores represents higher similarity between a chart and remaining charts the respective chart macro-cluster; and
program instructions to aggregate each calculated cluster relationship strength score into the relative micro-profiling impact score for the associated cluster.

18. The computer system of claim 15, wherein the chart parameters include normalized time scales, data color coding, text labeling, and associated annotations.

19. The computer system of claim 15, wherein the timeline generator is a generative adversarial network.

20. The computer system of claim 15, wherein the dataset is a timeseries dataset.
